(19) United States
(12) Patent Application Publication
(10) Pub. No.: US 2002/0129216 A1
(43) Pub. Date: Sep. 12, 2002

(54) Apparatus and method for configuring available storage capacity on a network as a logical device

(76) Inventor: Kevin Collins, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/799,654

(22) Filed: Mar. 6, 2001

(51) Int. Cl. G06F 12/00

(52) U.S. Cl. 711/170; 711/112

(57) ABSTRACT

An apparatus and method for configuring available storage capacity that is available on a network as a logical device for common use thereof. The invention is preferably embodied in computer readable program code. The available storage capacity may be identified by monitoring storage resources on the network (e.g., NAS, SAN, PC attached storage, server attached storage, etc.) and determining the available storage capacity thereof. The available storage capacity is allocated for common use as a logical device, and managed according to a management policy. For example, the logical device may be managed by translating between access protocols, routing data to the portion of the logical device best suited to store the data, etc.

### FIELD OF THE INVENTION

The invention pertains to identifying the available storage capacity of a plurality of storage resources on a network, and configuring the available storage capacity as at least one logical device for common use thereof.

### BACKGROUND OF THE INVENTION

Networks are commonly used to interconnect workstations, peripheral devices (e.g., printers, copiers, facsimile machines, etc.), servers, network area storage (NAS) devices, storage area networks (SANs), etc. Local area networks (LANs) are often used within an office or even a household. Wide area networks (WANs) are often used between remote locations (e.g., corporate departments via an intranet or even the Internet). Many networks include both LANs and WANs linked to one another for various purposes. However, these network structures do not necessarily make optimum use of the available storage capacity thereon.

The use of storage capacity varies among the various storage resources on the network. Some uses require significant storage capacity (e.g., for backup data, e-commerce and/or database management, etc.). Other uses require, by comparison, very little storage capacity (e.g., for storing individual user files, etc.). Likewise, storage capacity itself varies among the storage resources on the network. Newer storage resources may have more storage capacity than older resources, and SAN-based storage may have more storage capacity than the storage resources attached to an individual workstation. Therefore, some storage resources may have sufficient storage capacity, while other storage resources may have insufficient storage capacity.

As an illustration, consider a network having several workstations and servers, each with a thirty gigabyte storage device attached thereto, a network area storage (NAS) device having a total capacity of one-hundred gigabytes, and a storage area network (SAN) having a total capacity of five-hundred gigabytes. That is, the network has a total storage capacity of over six-hundred gigabytes, much of which may be unused storage capacity (e.g., three-hundred gigabytes may be unused). However, the storage capacity (or unused storage capacity) available to one or more of the devices on the network (e.g., a workstation, etc.) may be very little, if any. Thus, these devices may soon, if not already, require additional storage capacity (i.e., additional storage must be purchased and installed). However, at the same time, there is significant unused storage capacity available on the network. Therefore, the available storage capacity is not efficiently distributed on the network.

One solution is to grant one or more of the network devices access to a storage resource elsewhere on the network. However, the network device accessing such a storage resource must first determine whether storage capacity is available thereon. Where storage capacity is not available from a particular storage resource, the network device must continue to search for other storage resources shared on the network until it finds another one with sufficient storage capacity available for sharing. Once another storage resource has been identified, the network device accessing the other storage resource must then maintain a log identifying particular files that are stored at each of the various other storage resources so that the files can later be retrieved. This can become particularly burdensome when files are stored at multiple other storage resources. In addition, sharing storage resources at random may unnecessarily burden the network. For example, backup files that are rarely accessed may be stored to the hard disk drive of a server, thus needlessly cluttering and slowing the server. In addition, another user having access to the same storage resource may not recognize a remotely-stored file and delete it, or otherwise inadvertently delete or overwrite a remotely-stored file. Furthermore, the network device may not be compatible with the other storage resource. For example, a UNIX workstation may be unable to access the attached storage device of a Microsoft WINDOWS NT®-based personal computer (PC) on the network due to the access protocols each is operating under.

### SUMMARY OF THE INVENTION

The inventors have devised an apparatus and method for identifying the available storage capacity that is available from a plurality of storage resources on a network, and configuring the available storage capacity as at least one logical device for common use. The invention thereby enables “pockets” of otherwise available storage capacity in a network environment to be harnessed for common use, lowering the cost of storage by making efficient use of the storage already available.

An apparatus for configuring the available storage capacity of a plurality of storage resources on a network is preferably embodied in computer readable program code. Program code identifies the available storage capacity of the storage resources (e.g., storage attached to a server and/or a workstation, NAS devices, SAN-based storage, etc.). The program code for identifying the available storage capacity may comprise program code for monitoring the resources and program code for determining the available storage capacity thereon. For example, each of the storage resources may be polled by an administrator terminal, or the like, as to the available storage capacity thereof. Or for example, program code may be associated with each of the storage resources (e.g., operating on an attached workstation, server, NAS device processor, SAN management server, etc.). The program code may generate a signal (e.g., on a regular basis, at startup, when there is a change, etc.) indicating the available storage capacity of the associated storage resource. Alternatively, parameters for identifying the available storage capacity may be manually submitted via a suitable user interface. For example, a user may specify the total unused storage capacity of one or more storage resources, and/or may specify that a percentage of the unused storage capacity may be made available for common use over the network, etc.

In any event, when the available storage capacity is identified, program code allocates the identified storage capacity as at least one logical device for common use thereof (i.e., for access thereto via a unique path over the network). For example, the logical device appears or is identified as a separate storage resource accessible on the network.

Preferably, program code is also provided for managing the allocated storage capacity, for example, using a management policy. The management policy preferably includes a path (e.g., a network address and directory) and access protocol (e.g., Common Internet File System (CIFS), Network File System (NFS), etc.) for the storage capacity allocated from each storage resource. In addition, the management policy may include a classification of the storage by type (e.g., attached, NAS device, SAN, etc.) and/or the characteristics of the available storage capacity, (e.g., the physical capacity of the storage device, a percentage of the unused storage capacity available for allocation, access speed, etc.). The classification and/or characteristics may be used, for example, to create logical devices (or partitions thereon) having similar characteristics, manage the available capacity of the logical device, etc. For example, the access protocol may be translated so that devices using one protocol (e.g., CIFS) may access storage resources accessible only via another protocol (e.g., NFS). Or for example, data can be stored using the storage resource best suited for handling data of a specific type (e.g., backup data can be stored using SAN storage as opposed to server attached storage). The management policy may also include restrictions associated with the available storage capacity. For example, a slower device may be designated for backup only, no video, etc.

Program code is also preferably provided for blocking direct access to the allocated storage capacity. That is, the device (e.g., a workstation) may be unable to access the allocated storage capacity via a direct path to the storage resource (e.g., attached storage), and instead, may only be able to access the allocated storage capacity via a path to the logical device. Preferably, the device (e.g., the workstation) from which the storage was originally allocated is also unable to access the storage capacity allocated therefrom via the logical device, thus preventing data from being backed-up to the same physical device.

Also preferably, the available storage capacity is dynamically allocated. That is, when necessary to fulfill local storage needs from which at least a portion of the unused or available storage capacity was allocated (e.g., those of the network server and/or workstation, NAS device, SAN, etc.), the storage capacity is reallocated for direct access thereto. Files stored by others on a portion of the logical device to be reallocated may be transferred to other logical devices, or another portion of the same logical device before it is reallocated. Preferably, such transfer is transparent to the user. That is, the user is still able to access the files on the logical device using the same access path (e.g., drive and directory) regardless of the physical location of the file within the logical device.

A method for configuring the available storage capacity of a network as at least one logical device for common use thereof preferably comprises identifying the available storage capacity, allocating the identified storage capacity as the logical device, and managing access to the logical device. Identifying the available storage capacity may comprise, for example, monitoring the storage resources and/or determining the available storage capacity thereof. Allocating the available storage capacity may comprise, for example, identifying a path to the available storage capacity, identifying an access protocol for the available storage capacity, and/or classifying the available storage capacity. Managing access to the logical device may include, for example, routing access requests to a portion of the logical device best suited for the data based on the type of data to be stored thereon, and/or translating access protocols where necessary.

As such, unused storage capacity is efficiently distributed across the network. That is, the unused storage capacity that is identified as available is allocated as at least one logical device, allowing transparent access thereto regardless of its source. The logical device appears and is accessible via the network similarly to any other storage device on the network (e.g., via the “Network Neighborhood” icon on a MICROSOFT WINDOWS® operating system), whether it is allocated from a NAS device, a SAN, attached storage, etc. In addition, access to the allocated storage capacity is managed to block direct access thereto by the device from which it was originally allocated, so that the allocated storage capacity is not inadvertently overwritten. Likewise, outside access to a particular storage resource may be denied so as to protect sensitive data, while still allocating a portion of that storage resource for common use. In addition, data can be stored to the logical device regardless of the underlying access protocol, and data can be stored on the type of storage media best suited for the data to be stored thereon.

These and other important advantages of the invention will be further explained in, or will become apparent from, the accompanying description, drawings and claims.

### BRIEF DESCRIPTION OF THE DRAWINGS

Illustrative and presently preferred embodiments of the invention are illustrated in the drawings in which:

FIG. 1 is a block diagram showing various storage resources available on a network;

FIG. 2 is illustrative of a management policy;

FIG. 3 is a flow chart showing the steps of one embodiment of the invention;

FIG. 4 is a flow chart showing the steps of the invention, illustrating an embodiment for identifying available storage capacity;

FIG. 5 is a flow chart showing the steps of the invention, illustrating embodiments for allocating available storage capacity; and

FIG. 6 is a flow chart showing the steps of the invention, illustrating embodiments for managing a logical device.

### DESCRIPTION OF THE PREFERRED EMBODIMENT

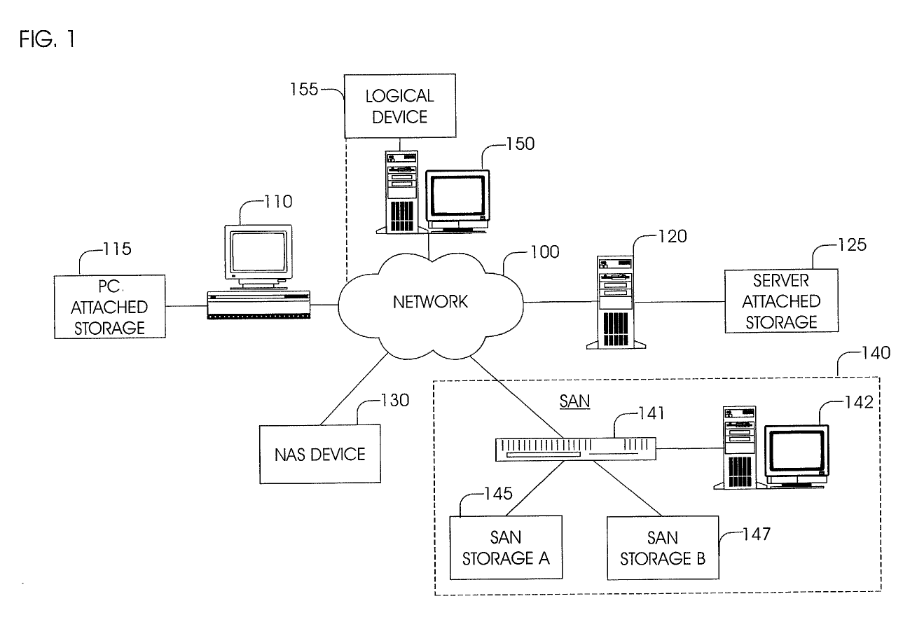

FIG. 1 shows a network 100 (e.g., a WAN, a LAN, an Intranet, the Internet) having a plurality of (i.e., preferably at least two) storage resources 110-140 thereon. For example, the storage resources may include a workstation 110 with attached storage 115, a server 120 with attached storage 125, a NAS device 130, and a SAN 140. The storage resources 110-140 may include any fixed or removable storage device and may be shared, password protected, etc. Indeed, others may even have read/write access thereto over the network 100, but access thereto is direct (i.e., obtained via a path to the storage resource itself). In addition, an administrator terminal 150 may be linked over the network 100 for providing a logical device 155 according to the teachings of the invention. The logical device 155 may be identified or appear on the network 100 and may be accessible therefrom (e.g., via the “Network Neighborhood” icon on a MICROSOFT WINDOWS® operating system) as described below.

It is understood that the term “storage resource”, as used herein, may be any suitable computer readable storage medium such as a hard disk drive, zip disk, compact disc (CD), magnetic tape, etc. In addition, the term “storage resource” may include the components associated with the storage medium itself. For example, the term “storage resource” may include the workstation 110 (e.g., a personal computer or PC) and an attached storage device 115 (e.g., a hard disk drive and/or CD, etc.), or to the server 120 and an attached storage device 125. As another example, the term “storage resource” when referring to the SAN 140 may include the entire “pool” of storage, and/or one or more of the individual components thereof, such as the fibre channel, hubs and switches 141, the central management server 142, the storage devices 145, 147 (e.g., tape libraries, centralized disk subsystem), etc. Also for example, the term “storage resource” when referring to the NAS device 130 may include the “thinserver” (i.e., a microprocessor and optimized operating system) and/or the disk subsystem.

It is understood that other devices (not shown) may also be linked over the network 100, such as peripheral devices (e.g., printers, scanners), routers, hubs, etc. Indeed, any number of storage resources 110-140 and other devices may be linked over the network 100. Furthermore, the storage resources 110-140 and other devices can be linked to the network 100 via any suitable means (e.g., modem, T-1, digital subscriber line (DSL), infrared, etc.), and may be linked through yet other devices (e.g., routers, hubs), other networks (e.g., LAN, Intranet), etc.

The invention is preferably embodied in firmware and/or software (i.e., computer readable program code), stored in computer readable storage media and executed, for example, at the administrator terminal 150, the workstation 110, the server 120, a combination thereof, etc. It is understood that the firmware and/or software may comprise more than one routine and/or subroutine, and may be embodied in separate components. In addition, the program code may be a stand-alone application, or may be a plug-in module for an existing application and/or operating system. Alternatively, the program code may be integrated into an application or operating system.

The following example illustrates one embodiment of storage distribution on the network 100. In this example, the storage resources 110-140 on the network 100 have a total capacity of eight-hundred-fifty gigabytes, as follows: 1) five workstations 110 each have attached storage 115 with individual capacities of thirty gigabytes; 2) two servers 120 each have attached storage 125 with individual capacities of fifty gigabytes; 3) the NAS device 130 has a total capacity of one-hundred gigabytes; and 4) the SAN 140 has a total capacity of five-hundred gigabytes. In addition, the total available capacity from each of these storage resources 110-140 is five-hundred gigabytes, as follows: 1) three workstations 110 have fifty gigabytes available through the attached storage 115; 2) one server 120 has twenty-five gigabytes available through the attached storage 125; 3) the NAS device 130 has seventy-give gigabytes available; and 4) the SAN 140 has two-hundred and fifty gigabytes available. Assume however, that the attached storage 115 and 125 of the two workstations 110 and the one server 120, respectively, have reached or are near capacity. Thus, these workstations 110 and server 120 require additional storage capacity (i.e., that an additional storage device be purchased and installed). At the same time, however, assume that there is five-hundred gigabytes of unused storage capacity available on the network 100. As such, the available storage capacity is not efficiently distributed on the network 120.

According to the teachings of the invention, storage capacity is efficiently distributed by identifying the available storage capacity on the network 100 (e.g., in a plurality of the storage resources 110-140), and allocating the identified storage capacity as at least one logical device 155 for common use. That is, the logical device 155 is identified on and accessible via the network 100. However, it is understood that the term “common use”, as used herein, may include a logical device 155 having restricted access to at least a portion thereof (e.g., via passcode protection), having dedicated access to at least a portion thereof (e.g., based on user identification), etc.

The following example illustrates one embodiment of storage distribution on the network 100 according to the teachings of the invention. Again, consider the storage resources 110-140 with the same characteristics as those given in the above example. According to the teachings of the invention, the unused storage capacity (i.e., five-hundred gigabytes) is identified on the network 100 and a portion is identified as available (e.g., 50% of the unused capacity is available). Thus, the storage capacity identified as available (e.g., two-hundred-fifty gigabytes) is allocated as a logical device 155 for common use. That is, the allocated storage capacity cannot be directly accessed without the consent of the person or program code managing the allocated storage capacity. Thus, the logical device 155 includes the aggregated or combined storage capacity that was identified for allocation (e.g., two-hundred-fifty gigabytes, in the above example). Thus, although two of the workstations 110 and one of the servers 120 have little, if any, available storage capacity, these workstations 110 and the server 120 can access the logical device 155 to store data thereon, and therefore another storage device need not necessarily be purchased and installed for use thereby. In addition, the logical device 155 may be accessed by the other devices having access thereto via the network 100.

It is understood that the unused and/or available storage capacity may be automatically identified. For example, the administrator terminal 150 polls each of the storage resources 110-140 on the network 100, or each storage resource 110-140 generates a signal (e.g., on a regular basis, at startup, when there is a change, etc.). In any event, the unused storage capacity is identified, and the available storage capacity (e.g., 10%, 80%, 100%) is identified as available to allocate as at least one logical device 155 for common use thereof. For example, where the attached storage 115 of the workstation 110 has a total capacity of thirty gigabytes, fifteen gigabytes of which is unused storage capacity, only ten gigabytes may be identified as available to allocate for common use. As such, a user at the workstation 110 (or a network administrator, etc.) requests that five gigabytes be reserved for direct access thereto to account for fluctuations in local storage requirements of the workstation 110.

It is also understood that the unused and/or available storage capacity may be manually identified. That is, an administrator or user (e.g., at the administrator terminal 150, at a workstation 110, through an interface at the network server 120, etc.) defines parameters for identifying the unused and/or available storage capacity. For example, a suitable user interface can be provided that allows the user to define parameters such as the number and type of storage attached thereto, the total storage capacity, the total unused storage capacity, a portion of the total unused storage capacity available to allocate and a portion to reserve for direct access, etc.

It is further understood that the unused and/or available storage capacity may be identified automatically and manually. For example, program code automatically identifies the total unused storage capacity, and the administrator or user identifies a portion of the total unused storage capacity that is available for allocation (e.g., 90%).

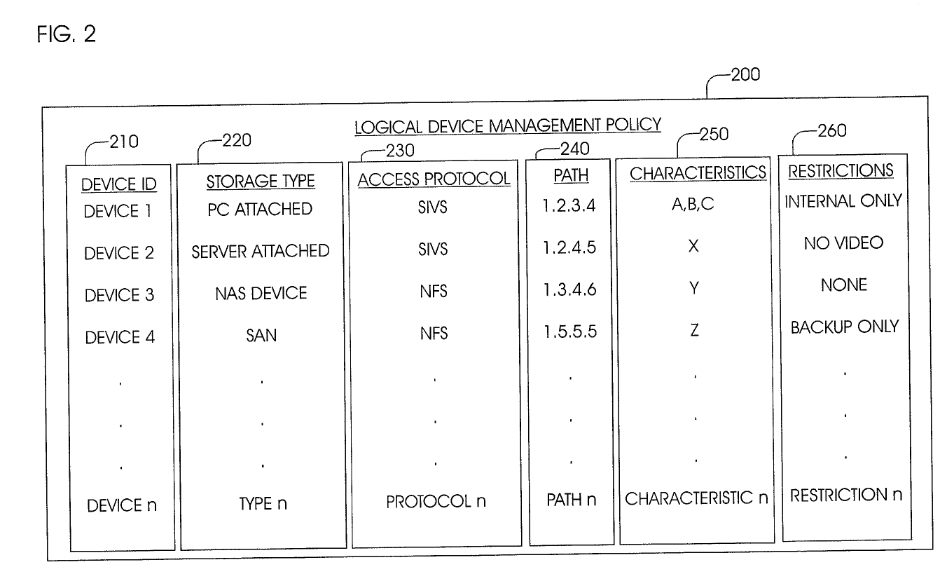

Once the available storage capacity is identified, the program code allocates the identified storage capacity as at least one logical device 155 for common use thereof. That is, the program code or administrator blocks the identified storage capacity from direct access thereto. The identified storage capacity may be, for example, partitioned or otherwise identified as a directory so that it can only be accessed as the logical device 155 via network 100. In other words, the portion of the storage resources 110-140 that have been allocated cannot be directly accessed, absent the consent of the person or program code managing the allocated storage capacity. Preferably, access to the logical device 155 is managed by the administrator terminal 130 using suitable program code, which may include suitable user interfaces for input and output therefrom, and a management policy 200 (FIG. 2), discussed below.

The management policy 200 may be used for management of the storage capacity allocated as the logical device 155 (e.g., at the administrator terminal 130) so that access thereto is transparent to the user. That is, the logical device 155 appears on the network 100 as one or more unique storage devices. The user is still able to access the files on the logical device 155 using the same access path (e.g., drive and directory) regardless of the physical location of the file within the logical device 155. This is preferably the case even where files must be stored at more than one physical location (e.g., due to capacity constraints at one or more physical location). The user is preferably not given an error message, such as “disk full” simply because one or more of the physical locations comprising the logical device 155 are at capacity, where the logical device 155 itself has available capacity (e.g., at another physical location). Instead, where a physical device reaches capacity as a file is being written to the physical device, the file may be split and stored at multiple physical locations, or the written portion of the file may be backed off of the physical device and rewritten to another physical device comprising the logical device 155. However, the user preferably only “sees” that the file has been written to a single, specified path on the logical device 155.

In addition, transparent access allows the logical device 155 to be accessed (i.e., to read and/or write data thereto) similarly to accessing any storage device 110 on the network 100. For example, a user may create a directory on the logical device 155 to store word processing files. Although the user saves each file to the same directory on the logical device 155, one file may be saved to storage capacity allocated from the NAS device 130, while another file may be saved to storage capacity allocated from the SAN 140, while yet another file may be saved to the server attached storage 125, or the workstation attached storage 115. However, regardless of the physical location of each file, the files are accessed via the same path (i.e., the single directory created on the logical device 155).

The allocated storage capacity (i.e., logical device 155) may be managed to provide efficient organization and use of the allocated storage capacity. That is, the management profile 200 may be used to track the type of storage allocated and to generate separate logical devices 155, or partitions on one or more logical devices 155, that have similar characteristics (e.g., attached storage, or NAS storage, or SAN storage, etc.). Alternatively, the management profile 200 may be used to track the type of storage allocated to a logical device 155 having various types of storage thereon and to route requests for access to the portion of the logical device 155 best suited for the data that is the subject of the access request. For example, backup requests may be routed to a portion of the logical device 155 allocated from the SAN 140, as opposed to the storage 115, 125 attached to a workstation 110 or server 120, respectively, which could cause the workstation 110 or the server 120 to slow during backup operations thereto.

In addition, the management policy 200 may be used to direct write requests on the logical device 155 to alternate physical storage resources 110-140. For example, where data stored on the server attached storage 125 is backed-up to the logical device 155, the back-up data is physically written to allocated storage capacity comprising the logical device 155 that is not allocated from the same storage resource (i.e., not to the same server attached storage 125, in this example). Thus, were server attached storage 125 to fail, the back-up data can still be retrieved from the logical device 155, as it has been written to a separate physical storage device. It is understood that management according to this embodiment may be limited to back-up requests where the access is identified as such (e.g., using a back-up application). Alternatively, such an embodiment may be a blanket policy for handling any data written to the logical device 155.

Furthermore, the allocated storage capacity (i.e., logical device 155) can be dynamically managed. That is, as storage requirements of the individual storage resources 110-140 change, additional storage capacity can be allocated to the logical device 155 and/or allocated storage capacity can be reallocated back to the individual storage resources 110-140. For example, where additional storage capacity becomes available at the NAS device 130, the same may be identified and allocated to the logical device 155. Also for example, where the server attached storage 125 requires additional storage capacity for direct access thereto (e.g., by server 120 or the workstations 110 that are served by server 125), a portion of the allocated storage capacity from the logical device 155 may be reallocated back to the server attached storage 125. Such allocation and reallocation may occur simultaneously on more than one storage device 110-140 on the network 100. Likewise, such allocation and reallocation may occur when it is requested by one or more of the storage resources 110-140, or when it is determined during polling, by an administrator, etc.

As a further illustration, the allocated storage capacity (i.e., logical device 155) can be manually managed via a system utility. For example, the system utility may be operable by a user at a workstation 110 to consolidate files on attached storage 115 and thus make storage capacity available for common use. The system utility may delete duplicate files, delete files that are no longer in use, defragment the attached storage 115, etc. Or for example, the system utility can be operated by the administrator to similarly consolidate files on one or more of the storage resources 110-140 on the network 100, and thus make storage capacity available for common use. It is understood, however, that such a utility need not be a “system” utility and can take any suitable form, such as a stand-alone application, applet, etc.

In another illustration, the allocated storage capacity (i.e., logical device 155) may be managed to provide transparent access thereto regardless of any number of a variety of access protocols in use by the various devices and storage resources 110-140 on the network 100. The management policy 200 may be used to track the access protocol of each portion of the logical device 155 based on the respective access protocol of the storage resource 110-140 from which it was allocated. As such, a request for access to the logical device 155 may be routed to a storage resource 110-140 using a similar protocol (e.g., where each uses NFS). Alternatively, the management policy 200 may be used to track and thus provide the necessary inputs (e.g., the required access protocol) to a routine for translating between access protocols. The routine preferably translates between the access protocol of the device requesting access and the storage resource(s) providing storage via the logical device 155 without compromising the respective file attributes or performance. The routine may provide, for example, IP address resolution using Domain Name Service (DNS) for UNIX-based storage resources and using Windows Internet Naming Service (WINS) for Microsoft WINDOWS NT®-based storage resources. Likewise, the routine may support file attributes (e.g., date and time stamp, file format, etc.), file naming conventions (e.g., eight character DOS-based names, extensions, etc.), “file locking” (e.g., for exclusive read/write access), etc., according to the appropriate protocol (e.g., NFS, CIFS, etc.).

The above examples are merely illustrative of management of the logical device 155, and other embodiments are contemplated as being within the scope of the teachings of the invention. The logical device 155 may also be managed with respect to characteristics and/or restrictions associated with the identified storage capacity. For example, some or all of the allocated storage capacity may be designated for internal use only. That is, the respective portion of the logical device 155 may only be accessed over a LAN or an intranet. Or for example, a portion of the logical device 155 may be passcode protected. In another example, a slow device may be designated as excluding video storage. Or for example, where a large sector of storage capacity is allocated from a single storage device, the respective portion of the logical device 155 may be designated for back-up data. Likewise, these characteristics can be used to create logical devices with similar characteristics (e.g., a logical device comprised of “fast” storage devices and another comprised of “slow” storage devices).

FIG. 2 shows an embodiment of a management policy 200. The management policy 200 may include a resource or device ID 210, a storage type 220, an access protocol 230, a path 240, characteristics 250, and restrictions 260. The device ID 210 identifies the storage resources 110-140 with unused capacity available for allocation. For example, the device ID 210 may be a generic identifier (e.g., Device 1), a fixed identifier (e.g., a network address), a combination thereof, etc. The storage type 220 identifies the type of storage that may be allocated from the corresponding device ID 210. For example, the storage type 220 may be attached storage, NAS storage, SAN storage, etc. The access protocol 230 identifies the protocol used by the storage that is allocated from the corresponding device ID 210. For example, a Microsoft WINDOWS NT®-based workstation 110 may operate according to NFS protocol for access to the attached storage 115, whereas a UNIX-based server 120 may operate according to CIFS protocol for access to the attached storage 125. The path 240 identifies the path to the identified storage capacity. For example, the path 240 may be a network address (e.g., IP address), a drive name, a directory or subdirectory, a combination thereof, etc. The characteristics 250 identify parameters of the storage resource 110-140 identified by the device ID 210. For example, the characteristics 250 may include the unused capacity available for allocation, the access speed, the percentage of unused capacity that can be allocated, etc. The restrictions 260 identify any restrictions associated with the storage resource 110-140 identified by the device ID 210. For example, the restrictions 260 may include the restriction “Internal Use Only”, indicating that the storage capacity is limited to access only via the intranet and no outside access is permitted (e.g., for security purposes). Or for example, the restrictions 260 may include the restriction “No Video”, indicating that the access thereto is slow; or “Backup Only”, indicating a large storage capacity.

It is understood that the invention is not limited to the management policy 200 shown and described with respect to FIG. 2. For example, in one embodiment the device ID 210 need not be included at all. Or for example, multiple restrictions 260 may be included for each device ID 210. Or as yet another example, the storage type 220 and/or restrictions 260 may instead be included as characteristics 250 or vice versa. Other embodiments are also contemplated as being within the scope of the teachings of the invention.

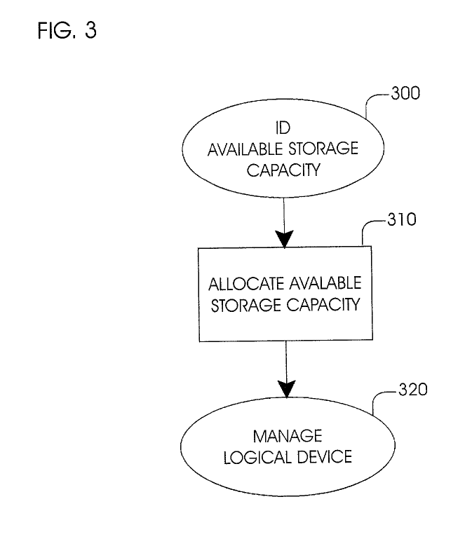

FIG. 3 illustrates an embodiment of the method of the invention. In step 300, the available storage capacity of the storage resources 110-140 on the network 100 is identified. Identifying the available storage capacity can be done automatically, manually, or via a combination thereof. For example, the administrator terminal 150 may poll each storage resource 110-140 on the network 100 to determine whether there is unused storage capacity available for allocation, as explained above. Or for example, an administrator or other user may identify available storage capacity using a suitable user interface and user-defined parameters, also as explained above. Or for example, the available storage capacity may be identified using a combination of user-defined parameters and automatically determined parameters. In step 310, the available storage capacity is allocated from the storage devices 110-140 as at least one logical device 155 for common access thereto. That is, the identified storage capacity is partitioned or otherwise sectioned (e.g., as a directory), a path 240 and access protocol 230 is logged (e.g., in management policy 200), and the identified storage capacity is made available via the network 100 as the at least one logical device 155. The logical device 155 may be accessed similarly to accessing any other physical storage resource 110-140 on the network 100. In step 320, the logical device 155 is managed for access thereto over the network 100. Preferably, the allocated storage capacity is blocked from direct access thereto so that data is not inadvertently overwritten, data is not backed-up to the same physical device, etc.

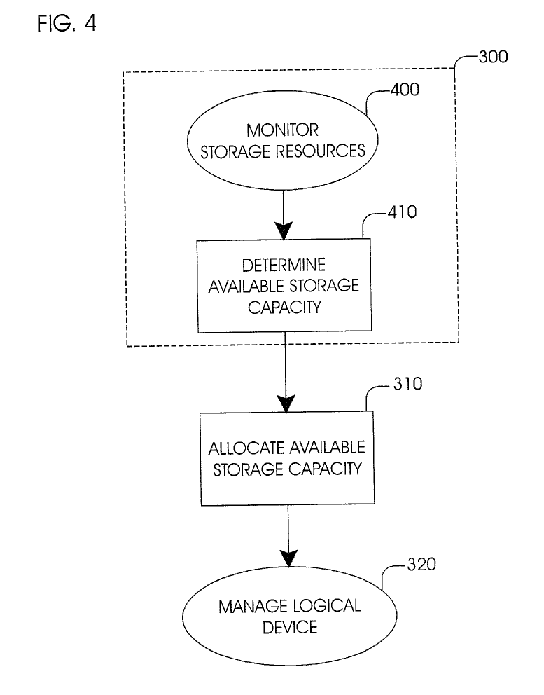

Another embodiment of the method of the invention is shown in FIG. 4, illustrating a preferred embodiment for identifying the available storage capacity (e.g., step 300 in FIG. 3). In step 400, the storage resources 110-140 on the network 100 are monitored, either automatically, manually, or a combination thereof. For example, the storage resources 110-140 are centrally monitored (e.g., via polling by the administrator terminal 150). Or for example, the storage devices 110 are self-monitored via self-executing program code or via a user (e.g., through a user interface). In step 410, the identified storage capacity is determined as available for allocation. For example, the user or an administrator specifies a portion of the unused storage capacity via a user interface that is available for allocation. Or for example, the same is automatically determined, or determined based on a combination of automatic and manual operations. Again, in step 310, the available storage capacity is allocated as at least one logical device 155, and in step 320, the logical device 155 is managed and made available for access thereto over the network 100.

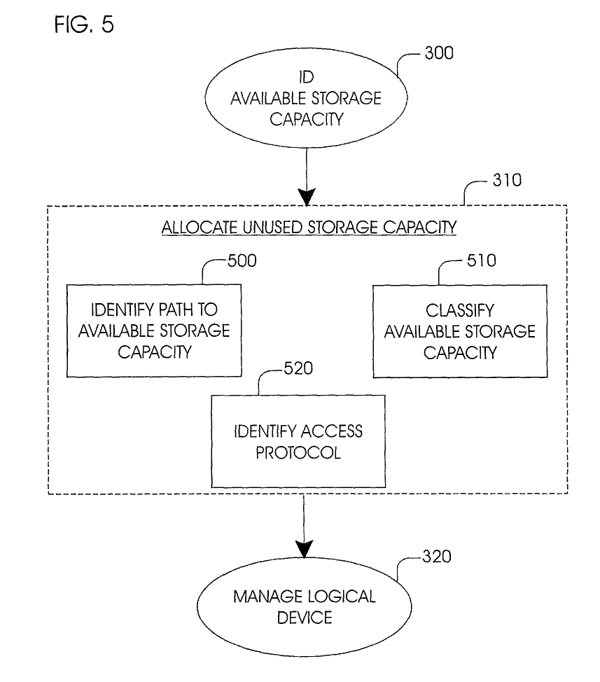

The method of the invention is also shown in FIG. 5, illustrating several preferred embodiments for allocating the available storage capacity (e.g., step 310 in FIG. 3). Again, in step 300, the available storage capacity is identified on the network 100. In step 500, a path (e.g., network address, device identification, directory, etc.) to available storage capacity may be identified. In step 510, the available storage capacity may be classified (e.g., by type as attached storage, NAS storage, etc.). In step 520, an access protocol may be identified for the available storage capacity. Such information may be stored, for example, in the management policy 200 for management of the at least one logical device 155 in step 320. It is understood that steps 500 through 520 need not occur in any particular order, nor need each of these steps occur in any given embodiment. Steps 500 through 520 are merely given as illustrations of steps in preferred embodiments of the method of the invention.

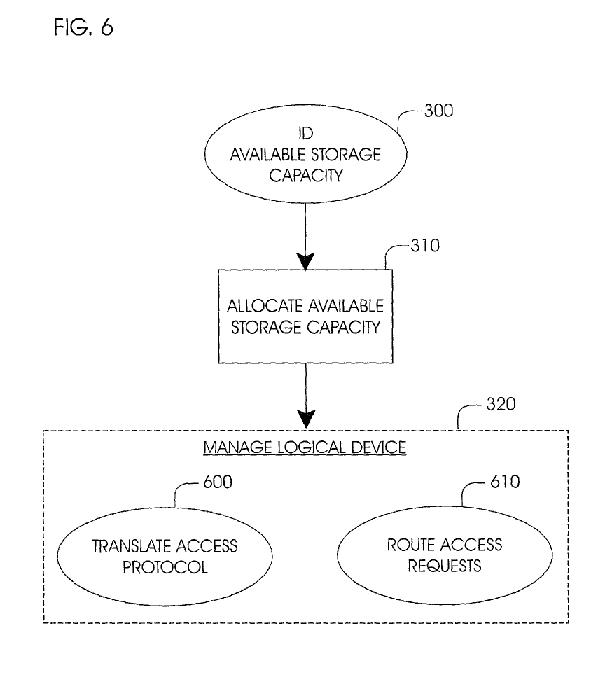

The method of the invention is also shown in FIG. 6, illustrating a preferred embodiment for managing the allocated storage capacity (e.g., step 320 in FIG. 3). Again, in step 300, the available storage capacity is identified on the network 100 and the available storage capacity is allocated in step 310. Preferably, a management policy 200 is generated (e.g., at the administrator terminal 150). The management policy 200 may be used to manage the allocated storage capacity (i.e., the logical device 155) in step 320. Such management of the logical device 155 may include making data stored thereon accessible via the network 100 by identifying a path to the logical device 155, as opposed to individual paths to each storage resource 110-140. For example, in step 600, the management policy 200 may be used to translate between access protocols (e.g., between that of the device requesting access and the storage resource(s) providing storage via the logical device 155). In step 610, the management policy 200 may be used to route requests for access to the portion of the logical device 155 best suited for the data that is the subject of the access request. It is understood that steps 600 and 610 need not occur in any particular order, nor need each of these steps occur in any given embodiment. Steps 600 and 610 are merely given as illustrations of preferred embodiments of the method of the invention. Another example may include managing the logical device 155 by directing write requests on the logical device 155 to alternate physical storage resources 110-140. Also for example, the logical device 155 may be managed by making access thereto transparent to the users on the network 100. In yet another example, the allocated storage capacity is managed by dynamically allocating and transparently reallocating storage capacity on the network 100. Other examples of managing the allocated storage capacity are also contemplated as being within the scope of the invention.

It is understood that the method of the invention is not limited to the various embodiments shown and described with respect to FIG. 3 through FIG. 6. For example, the steps shown in the various embodiments of these figures may be combined with one another. Or for example, the steps shown in the various embodiments of these figures may be substituted for one another. Likewise, the method can include additional steps not shown, but inherent under the teachings of the invention.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1) A method of configuring available storage capacity on a network, comprising:
a) identifying said available storage capacity of at least two types of storage resources on said network;
b) allocating said indentified storage capacity as a logical device; and
c) managing access to said logical device.

2) A method, as in claim 1, wherein identifying said available storage capacity comprises:
a) monitoring said storage resources on said network; and
b) determining said available storage capacity thereon.

3) A method, as in claim 1, wherein allocating said available storage capacity comprises identifying a path for access thereto.

4) A method, as in claim 1, wherein allocating said available storage capacity comprises identifying access protocols for said available storage capacity.

5) A method, as in claim 4, wherein managing access comprises translating said access protocols when a request for access to said logical device so requires.

6) A method, as in claim 1, wherein allocating said available storage capacity comprises classifying said available storage capacity.

7) A method, as in claim 6, wherein managing access comprises routing data to a portion of said logical device best suited for handling said data based on said classification of said available storage capacity.

8) A method, as in claim 1, wherein said allocated storage capacity is accessible only via said logical device.

9) A method, as in claim 1, further comprising transparently reallocating at least a portion of said logical device for direct access thereto when needed by said storage resource from which said available storage capacity was originally allocated.

10) An apparatus for configuring available storage capacity on a network, comprising:
computer readable storage media;
computer readable program code stored on said computer readable storage media, comprising:
a) program code for identifying said available storage capacity of at least two types of storage resources on said network;
b) program code for allocating said available storage capacity as a logical device; and
c) program code for managing said logical device.

11) An apparatus, as in claim 10, further comprising program code for monitoring said storage resources on said network to determine said available storage capacity thereon that is available for allocating.

12) An apparatus, as in claim 10, further comprising program code for generating a management policy for managing said logical device.

13) An apparatus, as in claim 12, wherein said management policy includes at least a path and an access protocol each corresponding to said allocated storage capacity.

14) An apparatus, as in claim 12, wherein said management policy includes characteristics of, and restrictions for access to, said allocated storage capacity.

15) An apparatus, as in claim 10, further comprising program code for blocking direct access to said allocated storage capacity.

16) An apparatus, as in claim 10, further comprising program code for reallocating at least a portion of said allocated storage capacity from said logical device for direct access thereto by said storage resource from which said available storage capacity was originally allocated.

17) An apparatus, as in claim 10, further comprising program code for routing data to a portion of said logical device best suited for handling said data.

18) An apparatus, as in claim 10, further comprising program code for translating at least one access protocol of said allocated storage capacity to provide access to said logical device.

19) An apparatus for configuring available storage capacity on a network for common use thereof, comprising:
means for identifying said available storage capacity on said network;
means for allocating said available storage capacity; and
means for managing said allocated storage capacity.

20) An apparatus, as in claim 19, further including means for routing data to a portion of said allocated storage best suited for handling said data.
